(19) United States
(12) Patent Application Publication
(10) Pub. No.: US 2006/0255089 A1
(43) Pub. Date: Nov. 16, 2006

(54) PNEUMATIC FASTENER DRIVING SYSTEM WITH SELF-CONTAINED GAS SOURCE

(75) Inventor: Stephen Patrick, Lively (CA)

Correspondence Address: DIMOCK STRATTON LLP, 20 QUEEN STREET WEST SUITE 3202, BOX 102, TORONTO, ON, M5H 3R3, CA

(73) Assignee: D&S PRODUCT SOLUTIONS INC., Lively (CA)

(21) Appl. No.: 11/460,004

(22) Filed: Jul. 26, 2006

Related U.S. Application Data
(62) Division of application No. 10/846,547, filed on May 17, 2004.

(51) Int. Cl. B25C 1/04

(52) U.S. Cl. 227/130; 227/156

(57) ABSTRACT

A self-contained pneumatic fastener driving tool that operates from a compressed gas canister supported by a local holder. The gas canister is either connected to the driving tool by a short pneumatic hose, in which case the gas canister is preferably secured to a belt or other device which is mounted on or attached to the user, or in some embodiments affixed to a local holder integrated into the driving tool, mounted alongside the handle of the tool, through the handle of the tool, or mounted directly to the drive head of the tool such that the gas canister itself serves as a handle for the tool. The gas canister provides a source of compressed gas sufficient for hundreds of strokes having the required percussive force, while not suffering from the constraints of attachment to an air compressor. The local canister holder may be expandable, to allow for canisters of different sizes and types to be mounted.

### FIELD OF THE INVENTION

This invention relates to pneumatic tools. In particular, this invention relates to a self-contained pneumatic fastener driving system.

### BACKGROUND OF THE INVENTION

A pneumatic fastener driver, commonly known as a “nail gun” or “air nailer,” is very useful for jobs require the driving of a large number of fasteners or the driving of fasteners in tight places where there is insufficient clearance to swing a hammer.

A typical pneumatic fastener driving tool has a drive head affixed to a fastener magazine having a spring-loaded feeder that feeds nails or brads to a fastener outlet. The drive head contains a pneumatic cylinder containing a piston that has a shaft or “driver blade” aligned with the fastener outlet. The cylinder is in communication with an air compressor, through a valve actuated by a trigger. When the trigger is depressed the cylinder is momentarily pressurized, driving the piston shaft against the fastener head to in turn drive the fastener into a workpiece, for example a piece of wood.

Typically the source of compressed gas for actuating the pneumatic fastener driving tool is an air compressor, and the tool is connected to the air compressor by a hose. The primary disadvantage of connecting the tool to a compressor using a hose is that the hose is limited in length, thereby restricted the distance between the tool and the air compressor. Accordingly, the compressor must always be within a certain distance of the pneumatic fastener driving tool. Moreover, the hose is subject to wear and tear by being dragged about during use, and can form a tripping hazard at a work site.

In some situations, for example where work needs to be done on the soffit of a house, either the pneumatic hose must be long enough to permit the extension of the tool to the desired location, for example to the top of an extension ladder, or the compressor must be elevated to allow the pneumatic fastener driving tool to reach the desired position. A long pneumatic hose can be unwieldy, rendering it difficult to manipulate the tool. On the other hand, an air compressor capable of driving such a tool is typically fairly heavy and therefore awkward to carry and/or support above the ground, and also requires an electrical power supply to operate. Moreover, where the job requires the application of fasteners over a long distance the compressor must be moved along as the user progresses, which can be cumbersome and inefficient.

It would accordingly be advantageous to provide a self-contained gas-driven fastener driving tool. Combustion gas-powered fastener driving tools have been proposed, for example that described and illustrated in U.S. Pat. No. 4,483,474 issued Nov. 20, 1984 to Nikolich, which is incorporated herein by reference. Such self-contained tools provide a chamber or reservoir for containing a combustible gas. Air is drawn from outside the tool and mixed with the gas in the cylinder, and ignited to drive the piston and thus the fastener. However, such devices are complex and the hand-held portion is heavy, requiring what is effectively a self-contained combustion engine in order to drive the fastener. This is in contrast to a compressor-driven pneumatic fastener driving tool, which has relatively few moving parts in the hand-held portion and is accordingly lighter and easier to manipulate and maintain.

It would accordingly beneficial to provide a self-contained pneumatic fastener driving tool that is simple and lightweight, without the complex mechanical construction required for a combustion gas-powered fastener driving tool.

### SUMMARY OF THE INVENTION

The present invention provides a self-contained pneumatic fastener driving system comprising a fastener driving tool that operates from a compressed gas canister and a local holder for mounting the gas canister in proximity of the tool. The gas canister is either connected to the tool by a short pneumatic hose, which is light and easy to manoeuvre, or in some preferred embodiments integrated into the driving tool itself. The gas canister provides a source of compressed gas sufficient for hundreds of strokes having the required percussive force to drive a large brad, while not suffering from the constraints of attachment to a bulky air compressor.

In embodiments of the invention the gas canister, for example a carbon dioxide (CO₂) bottle, may be mounted alongside a handle of the fastener tool, or through the handle of the fastener tool, or may be mounted directly to the drive head of the tool such that the gas canister itself serves as a handle for the tool.

According to another embodiment of the invention a compressed gas canister is coupled to a short pneumatic hose that is in turn coupled to the pneumatic fastener driver. The gas canister is preferably secured to a belt or other device which is mounted on or attached to the user. The tool belt or other canister holding device may be expandable, to allow for canisters of different sizes and types to be secured to the user.

The fastener driving tool of the invention accordingly provides a self-contained, lightweight and easy to manipulate fastener driver that can drive hundreds of fasteners before the gas canister needs to be changed or recharged. These and other advantages of the invention will become apparent from the description which follows.

The present invention thus provides a pneumatic fastener driving system, comprising a fastener driving tool having a fastener magazine for feeding fasteners to a fastener outlet and a drive head comprising a pneumatic cylinder containing a piston having a driver blade aligned with the fastener outlet and actuated by a valve for momentarily pressurizing the cylinder to drive a fastener, a gas canister, and a local holder for mounting the gas canister in proximity of the tool, wherein when the gas canister is charged and coupled to the tool the cylinder is pressurized when the valve is actuated.

The present invention further provides, in combination, a fastener driving tool having a fastener magazine for feeding fasteners to a fastener outlet and a drive head comprising a pneumatic cylinder containing a piston having a driver blade aligned with the fastener outlet and actuated by a valve for momentarily pressurizing the cylinder to drive a fastener, a gas canister, and a local holder for mounting the gas canister in proximity of the tool, wherein when the gas canister is charged and coupled to the tool the cylinder is pressurized when the valve is actuated.

The present invention further provides a kit of parts for a pneumatic fastener driving system, comprising a fastener driving tool having a fastener magazine for feeding fasteners to a fastener outlet and a drive head comprising a pneumatic cylinder containing a piston having a driver blade aligned with the fastener outlet and actuated by a valve for momentarily pressurizing the cylinder to drive a fastener, a gas canister, and a local holder for mounting the gas canister in proximity of the tool, wherein when the gas canister is charged and coupled to the tool the cylinder is pressurized when the valve is actuated.

### BRIEF DESCRIPTION OF THE DRAWINGS

In drawings which illustrate by way of example only a preferred embodiment of the invention,

FIG. 1 is a partially cutaway elevation of a first embodiment of the pneumatic fastener driving tool according to the invention, in which the canister is affixed to the head of the driving tool,

FIG. 2 is a perspective view of a further embodiment of a pneumatic fastener driving tool according to the invention, in which the canister is secured to a tool belt and affixed to the tool by a hose.

FIG. 3 is a perspective view of a canister holder for the tool belt of FIG. 2.

FIG. 4 is a perspective view of a fastener tool holder for the tool belt of FIG. 2.

FIG. 5 is a perspective view of a further embodiment of the fastener driving system of the invention, in which the canister is affixed directly to the tool alongside the tool handle.

FIG. 6 is a perspective view of a further embodiment of a fastener driving system of the invention, in which the canister is affixed directly to the tool to serve as the tool handle.

### DETAILED DESCRIPTION OF THE INVENTION

The fastener driving tool 10 of the invention will be described in the context of a nail driver or “nail gun” for driving nails or brads. It will be appreciated by those skilled in the art that the fastener driver could equally be a staple gun, roofing gun or any other hand-held tool that drives a fastener, and the invention is not limited to the particular fastener driving tool 10 so described.

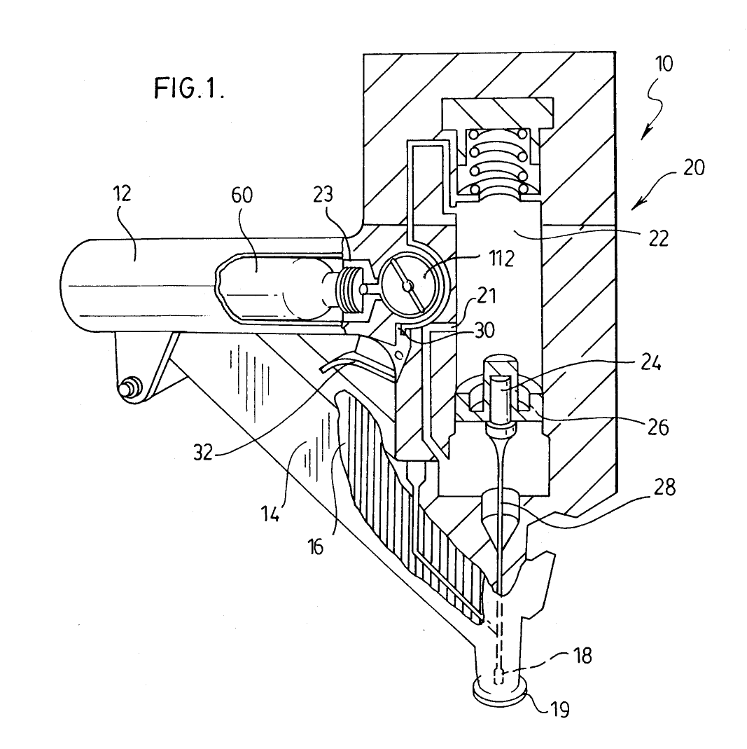

FIG. 1 illustrates a first preferred embodiment of the invention. A hand-held pneumatic fastener driving tool 10 has a drive head 20 affixed to a fastener magazine 14 having a spring-loaded feeder 16 that feeds nails or brads 2 to a fastener outlet 18. A handle 12 is affixed between the drive head 20 and the magazine 14, creating a stable, unitary construction that maintains the drive head 20 in proper alignment with the magazine 14. The pneumatic cylinder 22 contains a piston 24 mounted in a bearing 26 for axial reciprocation within the cylinder 22 and affixed to a shaft or “driver blade” 28 which is aligned with the fastener outlet 18. The cylinder 22 is in communication with the air inlet 21 through a valve 30 actuated by a trigger 32, such that when the trigger 32 is depressed the valve 30 is momentarily opened to momentarily pressurize the cylinder 22, driving the driver blade 28 against the head of the fastener 2 and thus in turn driving the fastener 2 out of the fastener outlet 18 and into a workpiece (not shown), for example a piece of wood. For safety reasons often the trigger 32 includes a secondary actuator which must be depressed to enable the trigger valve 30, for example a depressible nose 19 projecting from the fastener outlet 18, which ensures that the driving tool 10 will only operate when the fastener outlet 18 is safely pressed against a workpiece, as is conventional.

In the preferred embodiment of the fastener driving system of the invention illustrated in FIG. 1, the threaded neck 61 of a gas canister 60 is coupled to the head 20 via a local canister holder comprising a complementary threaded female receptacle 23 that is in communication with a regulator valve 112, provided in the drive head 20 between the cylinder gas inlet 21 and the coupling for the canister 60. The trigger valve 30 is interposed between the regulator valve 112 and the inlet 21. Optionally a pressure gauge (not shown) can be provided in the head 20, although the desired pressure (which determines the degree to which the fastener is set in the workpiece) can be easily attained by test firing brads 2 into the workpiece and increasing or decreasing the pressure as required to achieve the desired set depth.

The gas canister 60 may be any suitable compressed gas canister, for example a rechargeable carbon dioxide (CO₂) bottle which is preferred because it is readily available, provides a relatively constant pressure until it is almost empty, and is inexpensive to refill.

In the operation of the embodiment of FIG. 1, the user inserts a charged gas canister 60 through the handle 12 and attaches the threaded neck 61 to the complementary threaded receptacle 23 in the head 20. The user sets the pressure via regulator valve 112 and can thereafter use the tool 10 in the conventional manner. When the safety nose 19 is pressed against a workpiece and the trigger 32 is manually depressed, the trigger valve 30 opens momentarily to allow a burst of gas from the canister 60 into the cylinder 22. The pressurization of the cylinder 22 forces the piston 24 to drive the driver blade 18 against the brad 2 (or nail, staple or other fastener), which in turn drives the brad 2 into the workpiece.

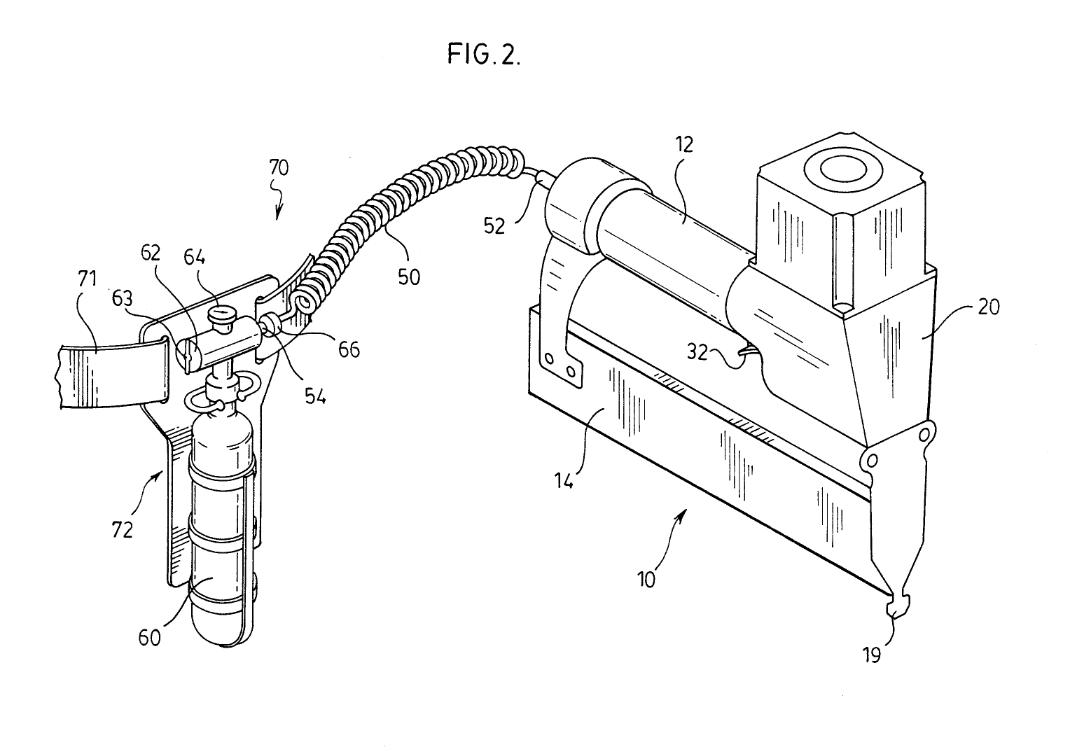

A further embodiment of the invention is illustrated in FIG. 2. The pneumatic cylinder 22 is in communication with an air inlet 40, typically disposed at the rear of the handle 12 and typically providing a male coupler end 42 of a quick-release connector.

A pneumatic hose 50 is provided having a female end 52 for coupling to the male coupler end 42 of the tool 10 and a male coupler end 54 for connection to a gas canister 60. In this embodiment the gas canister 60 is preferably coupled (typically by a threaded connection about the canister neck 61) to a regulator head 62 having a pressure regulator valve 63 for regulating the pressure of gas fed to the tool 10 (which determines the driving power and therefore the depth to which the nail or brad is driven), a pressure gauge 64, and a female coupler end 66 of a quick-release connector for attachment to the male coupler end 54 of the hose 50.

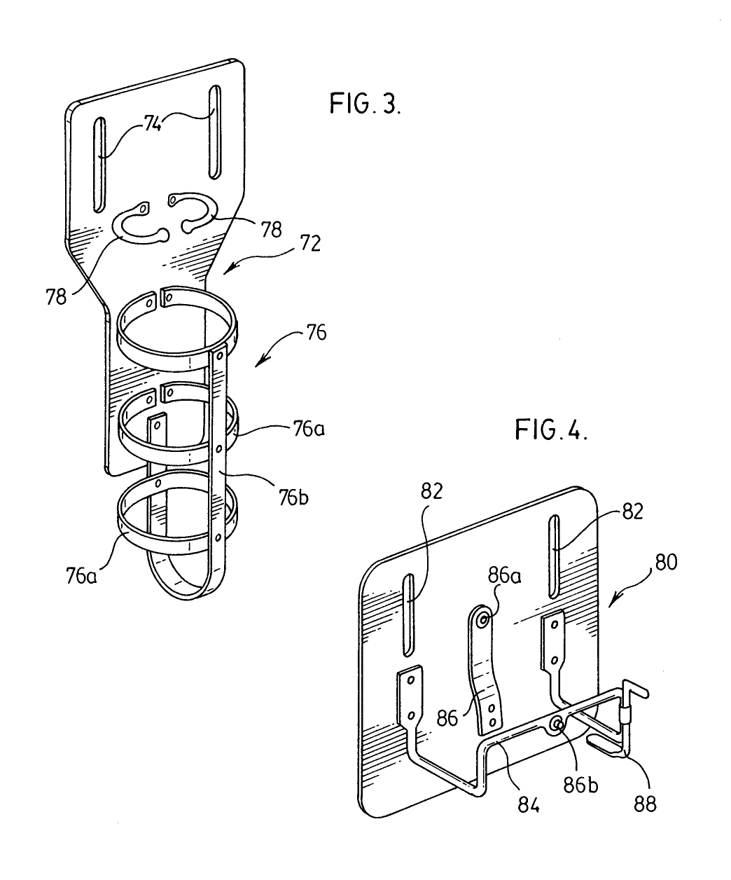

The fastener driving system of the invention provides a local holder for mounting the gas canister in proximity of the tool. In the first preferred embodiment the gas canister 60 is preferably mounted in a canister holder portion 72 of a tool belt 70. The canister holder portion 72, illustrated in FIG. 3, comprises slots 74 through which a belt 71 passes, a sheath or holster 76 comprising horizontal straps 76a affixed by a vertical strap 76b for supporting the canister 60, and a pair of U-shaped braces 78 for stabilizing the regulator head 62 when the canister 60 is mounted to the tool belt 70.

Preferably the tool belt 70 also provides a tool holder 80 for stowing the tool 10, illustrated in FIG. 4. The tool holder 80 comprises slots 82 through which the belt 71 passes, a support bracket 84 which supports the handle 12 of the tool 10, and a detachable strap 86 for attachment to the bracket 84 (for example by mating grommet portions 86a and 86b) to secure the tool 10 in the holder 80. In the preferred embodiment a trigger lock 88 is movably secured to the bracket 84 in a position which blocks the trigger 32 from being depressed while the tool 10 is in the holder 80.

In the operation of the embodiment of FIG. 2, the user threads a regulator head 62 to a charged gas canister 60 and couples the male coupler end 54 of the hose 50 to the female coupler end 66 of the regulator head 62. The female coupler end 52 of the hose 50 is connected to the male coupler end 42 at the air inlet 40 of the tool 10. The belt 71 is threaded through the canister holder 70 and the tool holder 80 and secured to the user. The canister 60 is mounted into the holster 76 and the tool 10 is mounted to the holder 80 and secured by the strap 86. The user sets the pressure via regulator 72 and can thereafter use the tool 10 in the conventional manner, replacing it in the holder 80 when finished.

A small (for example 9 ounce) gas canister 60 provides hundreds of strokes before requiring recharging. Preferably the holster 70 is expandable, for example being made from an elastic material or fabric fastener strips such as Velcro (trademark), to allow for gas canisters of different sizes to be securely mounted into the holster 70.

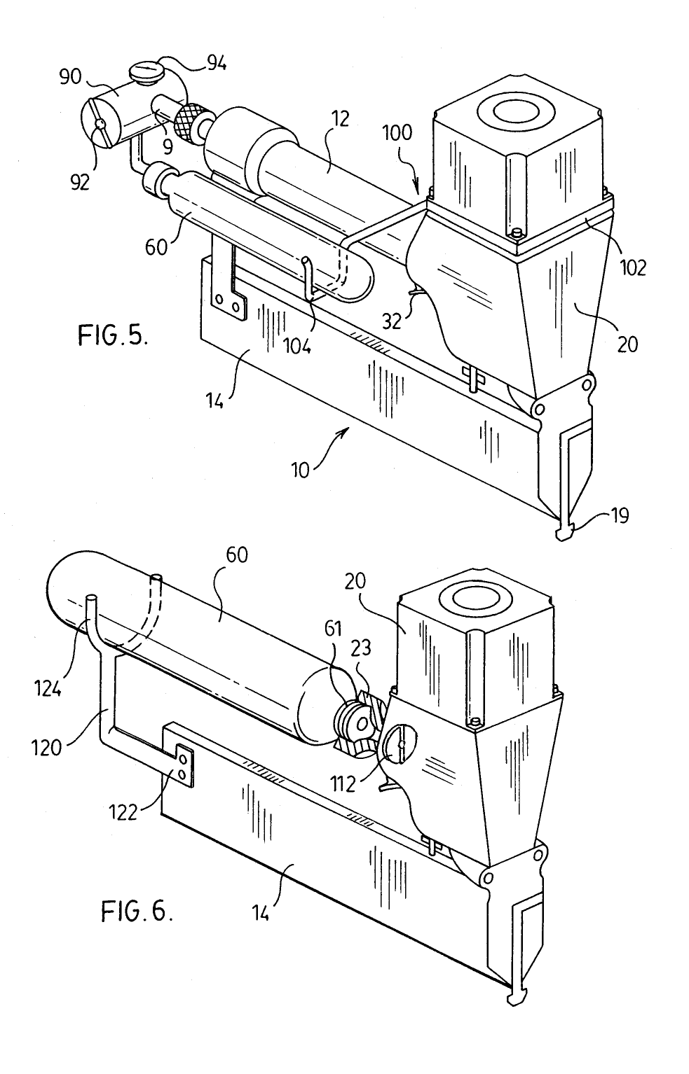

In a further embodiment of the invention, illustrated in FIG. 5, the gas canister 60 is coupled to a regulator head 90 having a regulator valve 92 and a pressure gauge 94, which provides a return coupler 96 for connection directly to the male coupler end 42 at the air inlet 40 of the tool 10. The local holder for mounting the gas canister 60 in proximity of the tool comprises a bracket 100 having a clamping portion 102 for affixing the bracket 100 to the drive head 20 and a hook or stirrup 104 for supporting the canister 60 opposite the regulator head 90. The operation of this embodiment is similar to that of the embodiment of FIG. 1. This embodiment is particularly suitable for retrofitting to existing pneumatic fastener driving tools 10.

In a still further embodiment of the invention, illustrated in FIG. 6, the gas canister 60 is coupled directly to the drive head 20 and also forms a handle for the tool 10. In the preferred embodiment a regulator valve 112 and optionally a pressure gauge (not shown) are provided in the drive head 20, and the trigger 32 is configured as in the embodiment of FIG. 1. The opposite end of the canister 60 is suitably supported by a bracket 120 having a portion 122 for affixing the bracket 100 to the rear end of the magazine 14 and a loop or stirrup 124 for supporting the canister 60. The operation of this embodiment is similar to the embodiment of FIG. 1, except that the canister 60 itself forms the handle of the tool, reducing the weight of the tool. In order to avoid user discomfort from cooling of the canister 60 when driving multiple fasteners 2 in rapid succession, optionally the canister 60 can be wrapped with a fabric, tape or the like (not shown) to insulate the user's hand.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A pneumatic fastener driving system, comprising
a fastener driving tool having a fastener magazine for feeding fasteners to a fastener outlet and a drive head comprising a pneumatic cylinder containing a piston having a driver blade aligned with the fastener outlet and actuated by a valve for momentarily pressurizing the cylinder to drive a fastener,
a gas canister, and
a local holder comprising a belt for mounting the gas canister in proximity of the tool,
wherein when the gas canister is charged and coupled to the tool the cylinder is pressurized when the valve is actuated.

2. The pneumatic fastener driving system of claim 1 wherein the belt comprises a holster for supporting the canister.

3. The pneumatic fastener driving system of claim 2 wherein the holster is expandable.

4. The pneumatic fastener driving system of claim 1 wherein the tool comprises a handle and the belt comprises a holder for supporting the tool by the handle.
